(19) United States
(12) Patent Application Publication
(10) Pub. No.: US 2025/0104559 A1
(43) Pub. Date: Mar. 27, 2025

(54) TRAFFIC FLOW OPTIMIZATION FOR A MULTI-CLASS VEHICLE NETWORK USING QUANTUM COMPUTING

(71) Applicant: PwC Product Sales LLC, New York, NY (US)

(72) Inventors: Arit Kumar BISHWAS, San Francisco, CA (US); Anuraj SOM, Kolkata (IN); Saurabh Sunil CHOUDHARY, Bhandara (IN); Bibhash Chandra MITRA, Burdwan (IN); Arindam MITRA, Howrah (IN)

(73) Assignee: PwC Product Sales LLC, New York, NY (US)

(21) Appl. No.: 18/473,748

(22) Filed: Sep. 25, 2023

(51) Int. Cl. G08G 1/0968; G06N 10/60; G08G 1/01

(52) U.S. Cl. CPC G08G 1/096844; G06N 10/60; G08G 1/0133; G08G 1/0141

(57) ABSTRACT

Described herein are techniques for optimizing real-time traffic flow of a multi-class vehicle network. In some embodiments, a trained machine learning model may be used to determine one or more segments of a street network where traffic congestion is predicted to occur at a predetermined future time. The vehicles may include a first type of vehicle and a second type of vehicle, each occupying different portions of a given segment. A subset of vehicles occupying the segments at the predetermined future time may be identified and, for each, a set of alternative routes may be determined. Quantum optimization data, including the pre-selected routes, the alternative routes, and an indication of whether the vehicle is of a first or second type, may be provided to a quantum computing system, which may return an updated route for at least some of the vehicles to minimize traffic congestion at the predetermined future time.

### TECHNICAL FIELD

This application relates generally to traffic flow optimization techniques for a multi-class vehicle network. In particular, this application relates to optimizing the traffic flow using quantum computing systems.

### BACKGROUND

Traffic flow optimization systems attempt to provide real-time optimization of traffic flow (e.g., via land, water, air, or other means of transport). The traffic flow optimization problem is crucial to developing a smart city, where proper control of traffic flow is needed to maintain smooth running of vehicles. In non-automated or partially-automated systems, traffic flow optimization may be used to provide routing guidance to human drivers and vehicle operators. In automated vehicle systems, traffic flow optimization may be used to automatically control vehicle navigation for individual vehicles and/or for connected or cooperative sets of vehicles navigating a common environment.

### SUMMARY

There are several real-life problems which either cannot be solved by classical computing techniques or will take an impractical amount of time to be solved by classical computing techniques. One example of such real-life problems includes the real-time optimization of traffic flow (e.g., via land, water, air, or other means of transport). The traffic flow optimization problem is crucial to developing a smart city, where proper control of traffic flow is needed to maintain smooth running of vehicles. The traffic flow optimization problem is considered an NP-hard problem. NP-hard problems refer to a class of problems where every problem P in NP (non-deterministic polynomial time) can be reduced in polynomial time. NP-hard problems can be found in cryptography, data mining, scheduling, routing, and other areas.

While many NP-hard problems cannot be solved practically using classical computing techniques, solutions can be obtained using quantum computing techniques. The traffic flow optimization problem is one such example. For example, the traffic flow optimization problem can be partitioned using a decomposing solver. The decomposing solver finds a minimum value of a large quadratic unconstrained binary optimization (QUBO) problem by splitting it into pieces. These pieces can be solved using a quantum computing system, such as a quantum annealer, or via a classical solver.

Some existing systems have approached the traffic flow optimization problem by treating all vehicles as equivalent to one another, for example by assuming that all vehicles have the same maneuverability, the same constraints, and contribute to congestion in an equivalent manner. This simplified version of the traffic flow optimization problem can be solved using existing quantum computing systems, such as a quantum annealer, by considering each vehicle of a vehicle network as being of the same type (e.g., car, truck, bike, etc.) and having a same source and destination in their respective routes. However, this version of the traffic flow optimization problem is not applicable for real-world use cases, where multiple types of vehicles are able to travel on a same portion of a route (e.g., a street). For example, traffic congestion may develop when a single segment of a route is occupied by two large vehicles (e.g., buses) as opposed to two smaller vehicles (e.g., bicycles). Thus, techniques for solving the traffic flow optimization problem of a multi-class vehicle network are needed.

Described herein are methods, systems, and programming for performing real-time traffic flow optimization for a multi-class vehicle network. Existing solutions to the traffic flow optimization problem are unable to handle vehicle networks including different classes of vehicles. For example, existing solutions have approached the traffic flow optimization problem by only considering a single class of a limited number of vehicles with the same source and destination in their route. This solution, however, is impractical for real-world scenarios where vehicle networks are composed of multiple classes of vehicles (e.g., cars, trucks, buses, bicycles, etc.).

In some embodiments, a method for optimizing real-time traffic flow of a multi-class vehicle network is provided. The method may comprise: determining, using a trained machine learning model operating on a classical computing system, one or more segments of a plurality of segments of a street network where traffic congestion is predicted to occur at a predetermined future time, wherein the one or more segments are predicted to be occupied at the predetermined future time by one or more vehicles of a plurality of vehicles of a multi-class vehicle network each traveling along a pre-selected route, wherein the plurality of vehicles include a first type of vehicle and a second type of vehicle, and wherein the first type of vehicle occupies a first portion of a segment and the second type of vehicle occupies a second portion of the segment; identifying, using the classical computing system, a subset of vehicles of the plurality of vehicles occupying the one or more segments at the predetermined future time; selecting, using the classical computing system, for each vehicle of the subset of vehicles, a set of alternative routes based on the pre-selected route of the vehicle; providing quantum optimization data to a quantum computing system, the quantum optimization data comprising the pre-selected route of each of the plurality of vehicles, the set of alternative routes for each of the subset of vehicles, and an indication of each vehicle as being the first type of vehicle or the second type of vehicle; and receiving, at the classical computing system, from the quantum computing system, an updated route for at least some of the plurality of vehicles that minimizes the traffic congestion at the predetermined future time. Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed can be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example system for optimizing real-time traffic flow in a multi-class vehicle network, in accordance with various embodiments.

FIG. 2A illustrates an example street network, in accordance with various embodiments.

FIG. 2B illustrates an example segment of a route of a vehicle of a multi-class vehicle network traveling from a source to a destination via the street network, in accordance with various embodiments.

FIG. 2C illustrates the example street network of FIG. 2A depicting an alternate route for a vehicle to travel from a source to a destination, in accordance with various embodiments.

FIG. 3 illustrates an example process for optimizing traffic flow of a multi-class vehicle network, in accordance with various embodiments.

FIG. 4 illustrates example traffic flow data stored in a traffic database, in accordance with various embodiments.

FIG. 5 illustrates an example process for training a machine learning model to predict segments where traffic congestion will occur at a future time, in accordance with various embodiments.

FIG. 6 illustrates a flowchart of an example method for optimizing real-time traffic flow in a multi-class vehicle network, in accordance with various embodiments.

FIG. 7 illustrates an example computer system used to implement some or all of the techniques described herein.

### DETAILED DESCRIPTION

Described herein are systems, methods, and programming for optimizing real-time traffic flow for a multi-class vehicle network. The problem of optimizing traffic flow is a known NP-hard problem. Partial solutions to this problem exist but these solutions rely on simplifying the problem to a single class of vehicles. However, in the real-world, vehicle networks often comprise multiple types of vehicles. For example, a street may be occupied at any given time by one or more cars, one or more trucks, one or more buses, one or more bicycles, or other modes of transportation. Even further, each type of vehicle itself can have a variety of sizes. For example, there are small, mid-sized, and large cars. Larger vehicles (e.g., buses, trucks) can hinder traffic flow more than smaller vehicles (e.g., sedans) because they occupy more of the street. Therefore, identifying the appropriate balance of vehicles, in both quantity and type, is crucial for optimizing traffic flow. This is particularly true when scaling the vehicle network up (e.g., 10³ or more vehicles, 10⁶ or more vehicles, 10⁸ or more vehicles, and the like).

In some embodiments, a current route for each vehicle of a multi-class vehicle network may be determined. The current route for a vehicle includes a source or start and a destination or end. Each route includes at least one segment. For example, to travel from point A to point B within a street network, a vehicle travels along at least one road. The source and destination for each vehicle's route can be mapped to a given node of a street graph representing the street network. The street network includes a plurality of interconnected segments (e.g., roads, paths, waterways, flightpaths, etc.). A node may be located at the intersection of the segments, as well as the ends/beginnings of segments for which there is no connecting segment. The source and destination are not always located on a node. Therefore, mapping the source and destination to a corresponding node allows for route planning to be performed. After the current route for each vehicle has been determined and mapped to proximate nodes on a street graph, one or more alternative routes having a same source and destination as the original route may be identified.

In some embodiments, one or more machine learning models may be implemented to predict segments that will experience traffic congestion at a predetermined future time. For example, at 6:00 PM EST of a current day, traffic flow along a 55^{th} Street between 5^{th} and 6^{th} Avenue in Manhattan may decrease below a threshold level, indicating that traffic congestion is occurring. Persons of ordinary skill in the art will recognize that other algorithmic prediction techniques (e.g., statistical models, randomization, etc.) may be used to predict the segments that will experience traffic congestion and the present disclosure is not limited to machine learning models. Based on the segments that are predicted to experience traffic, one or more vehicles currently occupying that segment may be determined. The particular vehicles may be determined by analyzing traffic flow data obtained from sensors resident on the vehicles of the multi-class vehicle network. For each of the vehicles determined to be occupying the segment, alternative routes may be selected from a set of candidate paths for a given source and destination based on how dissimilar the alternative routes are to the current route for that vehicle.

The current route and the alternative routes may be used to formulate a quantum unconstrained binary optimization (QUBO) problem. The QUBO problem accounts for the various possible routes (e.g., current route and alternative routes) while considering the occupancy cost of different segments as functions of the binary variables associated with the routes that share them. A constraint is imposed on each vehicle that one route has to be taken and the cost representing the congestion, which has to be minimized, is thus represented by the number and effect of each type of vehicle. In some embodiments, the QUBO problem may be provided to a quantum computing system configured to use quantum computing techniques to obtain a solution to the submitted QUBO problem. The solution that is produced by the quantum computing system may include an updated route for one or more vehicles of the vehicle network such that traffic congestion along one or more segments of the street network is minimized. The updated routes can then be re-analyzed to identify segments of traffic congestion, and the process can be repeated. In some embodiments, the process of determining the updated routes via formulation of the QUBO problem may be triggered in response to the segments with traffic congestions being identified.

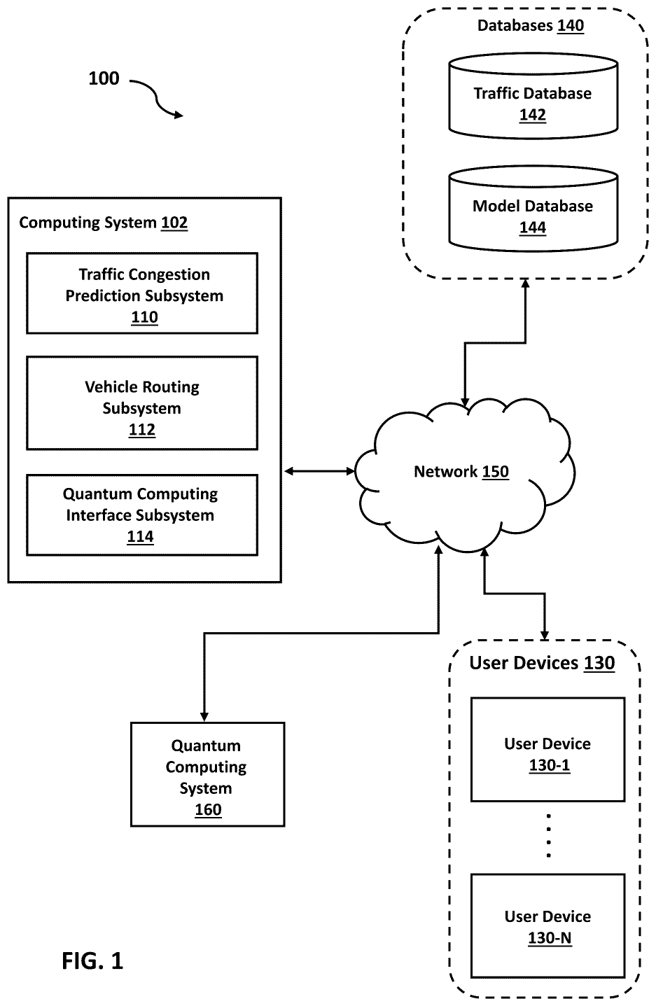

FIG. 1 illustrates an example system 100 for optimizing real-time traffic flow for a multi-class vehicle network, in accordance with various embodiments. System 100 may include a computing system 102, user devices 130-1 to 130-N (e.g., collectively referred to as “user devices 130”), databases 140 (e.g., traffic database 142, model database 144), a quantum computing system 160, or other components. In some embodiments, components of system 100 may communicate with one another using network 150, such as the Internet. In some examples, computing system 102 corresponds to a “classical” computing system to distinguish from quantum computing system 160. As described in greater detail herein, a classical computing system may perform classical computing operations, whereas a quantum computing system may execute quantum computing operations (e.g., quantum annealing).

User devices may be capable of communicating with one or more components of system 100 via network 150 and/or via a direct connection. User device 130 may refer to a computing device configured to interface with various components of system 100 to control one or more tasks, cause one or more actions to be performed, or effectuate other operations. For example, user device 130 may be configured to provide inputs to computing system 102 and/or quantum computing system 160 via network 150. Example computing devices that user devices 130 may correspond to include, but are not limited to, which is not to imply that other listings are limiting, desktop computers, servers, mobile computers, smart devices, wearable devices, cloud computing platforms, or other client devices. In some embodiments, each user device 130 may include one or more processors, memory, communications components, display components, audio capture/output devices, image capture components, or other components, or combinations thereof. Each user device 130 may include any type of wearable device, mobile terminal, fixed terminal, or other device.

It should be noted that, while one or more operations are described herein as being performed by particular components of computing system 102, user devices 130, and/or quantum computing system 160, those operations may, in some embodiments, be performed by other components of system 100. As an example, while one or more operations are described herein as being performed by components of computing system 102, those operations may, in some embodiments, be performed by components user devices 130. It should also be noted that, although some embodiments are described herein with respect to machine learning models, other prediction models (e.g., statistical models or other analytics models) may be used in lieu of or in addition to machine learning models in other embodiments (e.g., a statistical model replacing a machine-learning model and a non-statistical model replacing a non-machine-learning model in one or more embodiments). Furthermore, although a single instance of computing system 102 and quantum computing system 160 are depicted within system 100, additional instances of one or more of computing system 102 and/or quantum computing system 160 may be included.

Classical computers, such as computing system 102, perform calculations using information represented by binary digits (or “bits” for short). Each bit in a classical computing system can occupy one of two discrete states: a first state (“0”) or a second state (“1”). In the absence of any external forces, a classical system such as a bit will occupy a single, well-defined state indefinitely. Quantum computers, such as quantum computing system 160, on the other hand, perform calculations using information encoded in the quantum states of two-state quantum systems called “quantum bits” (or “qubits” for short). A quantum system can “collapse”, with a certain probability, to any physically allowed state when a measurement of the system's state is performed. Since the measurement result is probabilistically determined, several measurements of the state of the same quantum system will not necessarily yield the same result. This is because, unlike a classical system-which can only exist in one of its possible states-a quantum system such as a qubit can exist in any “superposition” (i.e., combination) of the independent, physically distinguishable quantum states in which the system can be observed or measured. This superposition state contains information about each of the possible independent quantum states as well as information related to the probability of observing the quantum system in each of the possible independent states. Since a quantum superposition state contains more information than a classical state, a single qubit (which can exist in any superposition of two independent states) is capable of representing a greater amount of information than a single classical bit (which can exist in only a single state at a time). As a result, quantum computers, such as are theorized to be capable of solving complex computational problems which classical computers are incapable of solving in practical amounts of time.

Although quantum computing systems, such as quantum computing system 160, have the potential to solve problems that classical computers cannot, such as NP-hard problems, quantum computing systems present various design challenges. Quantum computers store information in the quantum states of qubits; as such, the ability to accurately and precisely control the quantum states of qubits is absolutely essential to the development of scalable, functioning quantum computing systems. Quantum systems, however, are inherently fragile; as such, storing information in a quantum state for extended periods of time is difficult. Small fluctuations (e.g., thermal fluctuations) in the environment surrounding a system of qubits, for example, can disturb the state of the system and cause “decoherence”, which renders the quantum information contained in the qubit system inaccessible. One method of controlling the qubit states is to house systems of qubits in cryogenic environments (i.e., environments at temperatures below about −180° C./−292° F./93 K). Maintaining the controlled environment at cryogenic temperatures can reduce thermal fluctuations in the controlled environment, which may otherwise disturb the state of the qubit system. However, maintaining the environment at cryogenic temperatures means the any physical hardware used within the controlled environment must be capable of operating efficiently in a cryogenic environment. In addition, other mechanisms of qubit control beyond controlling the environment are needed in order to successfully perform quantum computations. These control mechanisms need to be scalable, accurate, and capable of functioning alongside one another.

Quantum computing system 160 may implement one or more types of quantum technology. Some example types of quantum technology include gate-based ion trapped processors, gate-based superconducting processors, photonic processors, neutral atom processors, Rydberg atom processors, quantum annealers, or other technologies. As an example, if quantum computing system 160 is a quantum annealer, the qubits of the quantum annealer may be placed in an absolute energy minimum. The systems configurations can be altered to reflect the type of problem to be solved.

To optimize the traffic flow of a multi-class vehicle network, the time required for each vehicle of a vehicle network to travel along their pre-selected route is to be minimized. As mentioned above, the vehicles of the vehicle network may travel along one or more routes of a street network. Each route may include at least one segment (e.g., a street). A source and destination of the route can be mapped to the closest node of the street network. The nodes are located at the intersections of segments, and at the starts/ends to segments which have no connection. An objective of the traffic flow optimization problem, therefore, can be to minimize the intersecting segments in the specified routes. Penalties can be allotted for the different types of vehicles proportionately to their effect the congestion in the route.

In the example traffic flow optimization problem, a same source and destination of each vehicle was maintained. Furthermore, for simplicity, each segment may fit a same amount of vehicles. For example, each street of a street network may be able to have a same occupancy size (e.g., each street has a same maximum occupancy). However, in practical applications, each segment may have a different size and thus segment size may also serve as an adjustable parameter when input to quantum computing system 160. Additionally, for simplicity, traffic flow is dependent only on a number of vehicles present in the route and each vehicle's type. Factors such as weather, time of day, accidents, and the like, can, in some embodiments, contribute to traffic congestion prediction and/or traffic flow optimization.

In some embodiments, computing system 102 may be configured to optimize traffic flow for a multi-class vehicle network. The multi-class vehicle network may include a plurality of vehicles (e.g., e.g., 10³ or more vehicles, 10⁶ or more vehicles, 10⁸ or more vehicles, and the like). The vehicles of the multi-class vehicle network may include one or more of a first type of vehicle, one or more of a second type of vehicle, and so on. Each type of vehicle may occupy a different amount of a given segment of a street network. The street network may include a plurality of segments. For example, the street network may include a plurality of segments. The first type of vehicle may occupy a first portion of a given segment while the second type of vehicle may occupy a second portion of the same segment when traveling along the segment. For example, if the first type of vehicle corresponds to a sedan, then these vehicles may occupy less of a segment of the street network than a truck.

Persons of ordinary skill in the art will recognize that although the foregoing description relates primarily to land-based vehicles, embodiments described herein are not limited to these vehicles. For example, the foregoing descriptions can be applicable for a variety of means of transportation including, but not limited to, trains, airplanes or other aeronautic machines, water-based machine (e.g., boats), or even pedestrian traffic flow. Furthermore, the techniques described herein can be expanded to include scenarios where multiple modes of transportation are included (e.g., a street network where vehicles and pedestrians travel). As described herein, the term “vehicle” can refer to a car (e.g., sedan, sport utility vehicle, minivan, etc.), truck (e.g., construction vehicles, emergency vehicles, delivery vehicles, etc.), a bicycle or other manually or semi-manually propelled vehicle (e.g., unicycle, tricycle, etc.), boat, airplane, motorcycle, or other type of vehicle, or combination thereof. Further still, the vehicles described herein can be human-operated, autonomous, or semi-autonomous.

Computing system 102 may include a traffic congestion prediction subsystem 110, a vehicle routing subsystem 112, a quantum computing interface subsystem 114, or other components. Each of traffic congestion prediction subsystem 110, vehicle routing subsystem 112, and quantum computing interface subsystem 114 may be configured to communicate with one another, one or more other devices, systems, servers, etc., using one or more communication networks (e.g., the Internet, an Intranet). System 100 may also include one or more databases 140 (e.g., traffic database 142, model database 144) used to store data for training one or more machine learning models, store one or more machine learning models that have been trained or that are to be trained (or re-trained), or storing other data used by one or more components of system 100. This disclosure anticipates the use of one or more of each type of system and component thereof without necessarily deviating from the teachings of this disclosure. Although not illustrated, other intermediary devices (e.g., data stores of a server connected to computing system 102) can also be used.

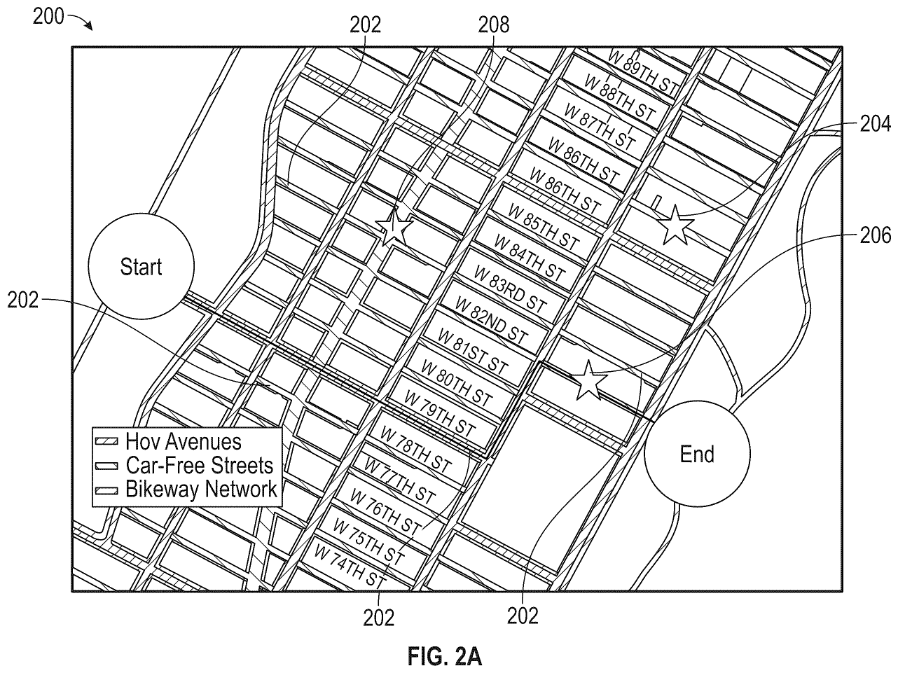

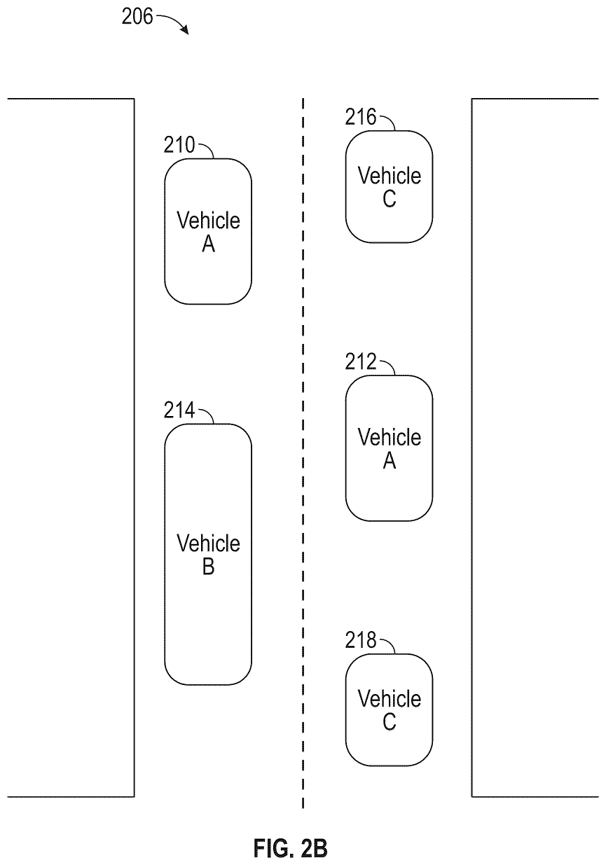

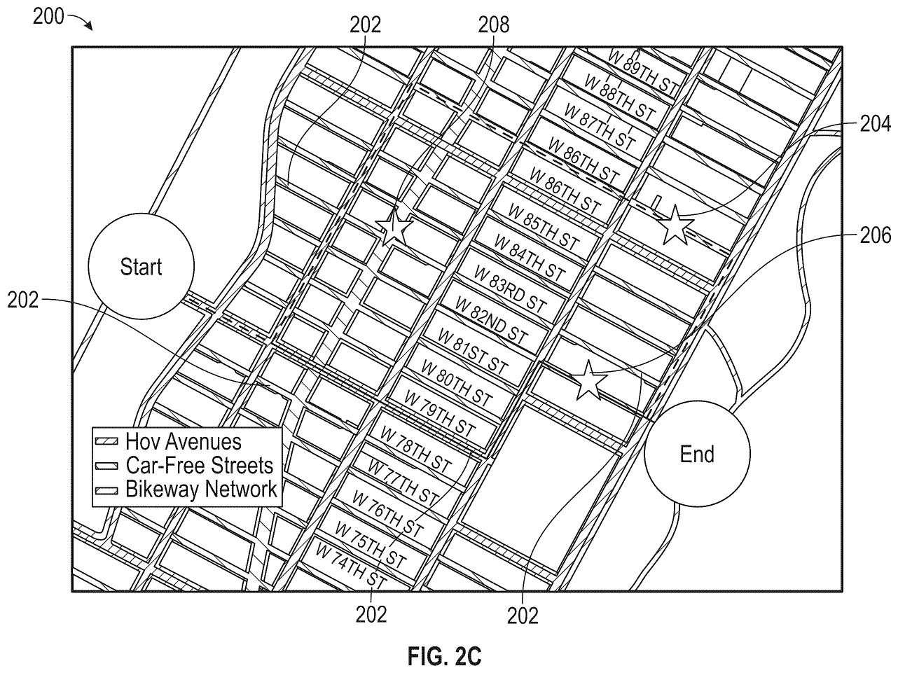

In some embodiments, traffic congestion prediction subsystem 110 may be configured to determine, using a trained machine learning model, one or more segments of a plurality of segments of a street network where traffic congestion is predicted to occur at a predetermined future time. As an example, with reference to FIG. 2A, a street network 200 is illustrated including a plurality of segments 202. For instance, the street network may comprise roads capable of being traveled on via vehicles such as automobiles, trucks, buses, bicycles, skateboards, and the like. For illustrative purposes, each segment may have a same size. However, in some embodiments, a size of a segment may vary (e.g., fewer vehicles can maximally occupy a two-lane road than can occupy a four-lane road).

A multi-class vehicle network including a plurality of vehicles of various types may be distributed about a street network, such as street network 200. The distribution of the vehicles may include assigning each vehicle with a source/start and a destination/end, and a pre-selected route to be traveled by that vehicle to go from the source/start to the destination/end. In the example of FIG. 2A, an exemplary vehicle may be assigned a route, indicating by the bold black line, from the start (“START” in the figure) to the end (“END” in the figure). In some cases, a vehicles start and/or end may be located at

In one or more examples, segments 202 are occupied at the predetermined future time by one or more vehicles of a plurality of vehicles of a multi-class vehicle network. Each vehicle can be assigned a pre-selected route to travel. In some examples, the street network comprises a plurality of segments, and each pre-selected route comprises at least one of the plurality of segments. For example, a given vehicle can travel along the route illustrated by the bold black line from the start to the end, which includes one or more segments 202. In one or more examples, each pre-selected route comprises at least one segment to be traveled by a corresponding vehicle.

In some embodiments, one or more segments of street network 200 may experience traffic flow minimization, also referred to as traffic congestion or traffic jams. With reference to FIG. 2B, segments 204, 206, and 208 each represent a segment of street network 200 where traffic flow minimization is detected and/or predicted to occur. For example, segment 206 from FIG. 2B illustrates five vehicles 210-218 are traveling along segment 206 at the same time (or within a same time interval). In some embodiments, the plurality of vehicles include a first type of vehicle and a second type of vehicle. For example, vehicles 210-218 may include a first vehicle 210 and a second vehicle 212, each of which correspond to a first type of vehicle (e.g., a mid-size car). Vehicles 210-218 may further include vehicle 214 which corresponds to a second type of vehicle (e.g., a truck). The plurality of vehicles may include additional types of vehicles. For example, vehicles 210-218 may further include vehicles 216 and 218, which correspond to a third type of vehicle (e.g., motorcycle). Some example vehicles may include a bicycle, compact car, midsized car, large car, crossover, sport utility vehicle (SUV), pickup truck, limousine, motorcycle, bicycle, truck (e.g., construction trucks, utility trucks, mail truck, emergency truck), bus (e.g., multiple sizes of bus), and the like.

Each type of vehicle may occupy a given amount of a segment. For instance, vehicles 210 and 212 may be of a first type of vehicle occupying a first portion of segment 206 (e.g., 10% or more, 15% or more, 20% or more, etc.) and vehicle 214 may be of a second type of vehicle occupying a second portion of segment 206 (e.g., 20% or more, 25% or more, 30% or more, etc.). Thus, assuming each segment is the same size, a quantity of vehicles of the first type and a quantity of vehicles of the second type may indicate how “occupied” a given segment is.

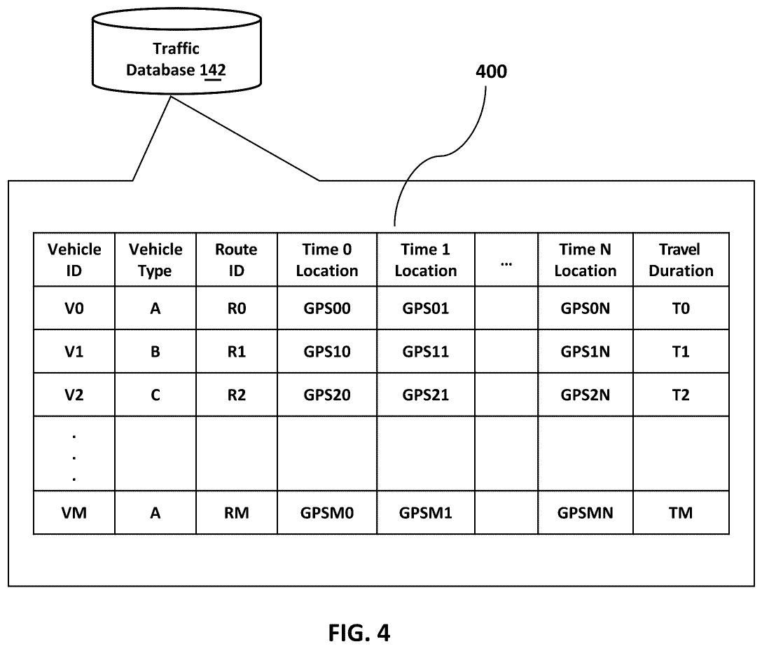

In some embodiments, traffic congestion prediction subsystem 110 may be configured to access traffic flow data indicating locations about the street network where each of the plurality of vehicles is located during a plurality of prior time intervals. The traffic flow data may be stored, for example, in traffic database 142. The traffic data may include indications of a location about street network 200 of each vehicle of the multi-class vehicle network. Additional details about the traffic data is illustrated in FIG. 4 below. In some examples, the traffic data may include trajectory data of a set of vehicles, for example taxis, recorded over one week of time. For example, the publicly available T-Drive trajectory database may be used including ˜15 million data points for ˜ 20 vehicles. Each vehicle may transmit a location signal every few seconds (e.g., 1-5 seconds).

In one or more examples, the traffic flow data may be input to the trained machine learning model to obtain the one or more segments of the street network where traffic congestion is predicted to occur at the predetermined future time. The trained machine learning model may be implemented by traffic congestion prediction subsystem 110. In some embodiments, the machine learning model may be trained to detect the one or more segments by determining a vehicle-segment occupancy score for each segment during each of a plurality of future time intervals. The segments may be selected based on the vehicle-segment occupancy score for each of the one or more segments being greater than or equal to a threshold segment occupancy score.

In some examples, the vehicle-segment occupancy score may be computed by traffic congestion prediction subsystem 110 implementing the trained machine learning model. For example, the vehicle-segment occupancy score may be computed by determining a number of vehicles of the first type of vehicle and a number of vehicles of the second type of vehicle occupying a same segment at the plurality of future time intervals. For each same segment, a first amount of space occupied by the number of vehicles of the first type of vehicle may be calculated. Furthermore, for each same segment, a second amount of space occupied by the number of vehicles of the second type of vehicle may be calculated. In one or more examples, the vehicle-segment occupancy score may be computed based on the first amount of space occupied, the second amount of space occupied, and a maximum vehicle-segment occupancy amount.

In some examples, segments where traffic flow is minimized may be predicted based on the historical traffic data stored in traffic database 142. Thus, traffic flow of the multi-class vehicle network can be maximized by minimizing a number of segments where traffic flow minimization occurs. The trained machine learning model can learn patterns in traffic flow that cause traffic flow minimization, also referred to as traffic congestion or traffic jams (or sometimes even as “traffic”) based on the historic data (e.g., vehicle locations over a period of time, vehicle type, start/end nodes, etc.). For example, the trained machine learning model may be a convolutional neural network trained to learn patterns in traffic flow causing traffic flow minimization. The trained neural network can output, for each segment, a probability that the segment will experience traffic congestion at one or more future times or that the segment will not experience traffic congestion at those times.

The machine learning techniques that can be used in the systems/subsystems/modules described herein may include, but are not limited to (which is not to suggest that any other list is limiting), any of the following: Ordinary Least Squares Regression (OLSR), Linear Regression, Logistic Regression, Stepwise Regression, Multivariate Adaptive Regression Splines (MARS), Locally Estimated Scatterplot Smoothing (LOESS), Instance-based Algorithms, k-Nearest Neighbor (KNN), Learning Vector Quantization (LVQ), Self-Organizing Map (SOM), Locally Weighted Learning (LWL), Regularization Algorithms, Ridge Regression, Least Absolute Shrinkage and Selection Operator (LASSO), Elastic Net, Least-Angle Regression (LARS), Decision Tree Algorithms, Classification and Regression Tree (CART), Iterative Dichotomizer 3 (ID3), C4.5 and C5.0 (different versions of a powerful approach), Chi-squared Automatic Interaction Detection (CHAID), Decision Stump, M5, Conditional Decision Trees, Naive Bayes, Gaussian Naive Bayes, Causality Networks (CN), Multinomial Naive Bayes, Averaged One-Dependence Estimators (AODE), Bayesian Belief Network (BBN), Bayesian Network (BN), k-Means, k-Medians, K-cluster, Expectation Maximization (EM), Hierarchical Clustering, Association Rule Learning Algorithms, A-priori algorithm, Eclat algorithm, Artificial Neural Network Algorithms, Perceptron, Back-Propagation, Hopfield Network, Radial Basis Function Network (RBFN), Deep Learning Algorithms, Deep Boltzmann Machine (DBM), Deep Belief Networks (DBN), Convolutional Neural Network (CNN), Deep Metric Learning, Stacked Auto-Encoders, Dimensionality Reduction Algorithms, Principal Component Analysis (PCA), Principal Component Regression (PCR), Partial Least Squares Regression (PLSR), Collaborative Filtering (CF), Latent Affinity Matching (LAM), Cerebri Value Computation (CVC), Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA), Ensemble Algorithms, Boosting, Bootstrapped Aggregation (Bagging), AdaBoost, Stacked Generalization (blending), Gradient Boosting Machines (GBM), Gradient Boosted Regression Trees (GBRT), Random Forest, Computational intelligence (evolutionary algorithms, etc.), Computer Vision (CV), Natural Language Processing (NLP), Recommender Systems, Reinforcement Learning, Graphical Models, or separable convolutions (e.g., depth-separable convolutions, spatial separable convolutions).

Returning to FIG. 1, vehicle routing subsystem 112 may be configured to generate and/or assign a route to a vehicle based on an initial route selected for the vehicle, an updated route identified from a solution to a QUBO problem submitted to and solved by quantum computing system 160, or based on other criteria, or a combination thereof.

As an example, with reference to FIGS. 2A-2C, as mentioned above, street network 200 includes a pre-selected route (bold black line) for a vehicle traveling between a source (e.g., “START”) and a destination (e.g., “END”). However, included in the pre-selected route is a segment 206 which is predicted to experience traffic flow minimization at a particular future time (or times). The traffic flow minimization, as seen from FIG. 2B, may occur when a vehicle-segment occupancy score for segment 206 exceeds a threshold vehicle-segment occupancy score.

In some embodiments, vehicle routing subsystem 112 may be configured to identify a subset of vehicles of the plurality of vehicles occupying the one or more segments at the predetermined future time. For example, with reference again to FIG. 2B, vehicle routing subsystem 112 may determine that vehicles 210-218 are each traveling along segment 206 during a predetermined future time, and segment 206 is predicted as having traffic flow minimized during the predetermined future time.

FIG. 2C illustrates street network 200 however including an alternative route for the vehicle to travel from the same source to the same destination. As seen in FIG. 2C, an alternative route is illustrated in FIG. 2C by the dashed black line. The alternative route may have the same source and destination as the pre-selected route from FIG. 2A, but can be dissimilar to the pre-selected route. For example, the alternative route may share a minimum number of segments with the pre-selected route.

In some embodiments, vehicle routing subsystem 112 may further be configured to select, for each vehicle of the subset of vehicles, a set of alternative routes based on the pre-selected route of the vehicle. In other words, alternative routes for each of vehicles 210-218 may be determined. In one or more examples, vehicle routing subsystem 112 selecting the set of alternative routes may comprise, for each vehicle of the subset of vehicles, identifying a plurality of candidate routes based on the pre-selected route. Each candidate route may include a same source and destination as the pre-selected route. In some examples, vehicle routing subsystem 112 may be configured to compute a similarity score indicating how similar each candidate route is to the pre-selected route. For example, the similarity score may be higher when the pre-selected route and the candidate route share more segments.

In some embodiments, one or more networking models may be used to generate/select routes. For example, the NetworkX model, as detailed in “Exploring Network Structure, Dynamics, and Function using NetworkX,” from Hagberg et al., 2008, the disclosure of which is hereby incorporated by reference in its entirety, may be used to identify an initial set of routes for the plurality of vehicles. The structure of a network, or graph, is encoded in the edges (connections, links, ties, arcs, bonds) between nodes (vertices, sites, actors). The networking models may be configured to determine a degree distributions (number of edges incident to each node), clustering coefficients (number of triangles each node is part of), shortest paths, spectral measures, and/or communities. In some embodiments, vehicle routing subsystem 112 may be configured to select the initial set of routes based on the networking model's analysis of the source/destination pairs (e.g., nodes) and the segments connecting those nodes. In one or more examples, the networking model may identify all candidate routes connecting a given source and destination. From the identified source/destination pairs, the initial set of routes may be selected based on total distance, total estimated time to traverse, or other metrics, or combinations thereof.

In one or more examples, vehicle routing subsystem 112 may be configured to select the set of alternative routes based on the similarity score computed for each of the plurality of candidate routes. In one or more examples, vehicle routing subsystem 112 may select the set of alternative routes using one or more networking models (e.g., NetworkX). In some examples, the set of alternative routes comprises routes that are most dissimilar to the pre-selected route. In some examples, the set of alternative routes may comprise at least three alternative routes. The candidate routes for each vehicle of the multi-class vehicle network may be ranked in order of dissimilarity, and a top-k candidate routes may be selected for inclusion within the set of alternative routes. Here, the variable k can be a configurable parameter, for example, two or more, three or more, ten or more, etc.

In one or more examples, the similarity score may be computed by computing a Jaccard Similarity Index for each candidate route and the pre-selected route. For example, for each vehicle of the multi-class vehicle network, all candidate paths from the vehicle's source to the vehicle's destination may be determined. A constrain may be applied that says that no vehicle can return to a previously visited node (e.g., therefore can only travel along a given segment once). Therefore, the most dissimilar candidate routes will have the lowest number of overlapping segments with the preselected route. The Jaccard similarity index, J (x, y), can be calculated using Equation 1:

$$J ( x , y ) = \frac{{\sum }_{i} min ( {x}_{i} , {y}_{i} )}{{\sum }_{i} max ( {x}_{i} , {y}_{i} )} . \qquad Equation 1$$

In Equation 1, xᵢ and yᵢ correspond to segments of two routes (e.g., a pre-selected route and a candidate route) for a given vehicle. Both of xᵢ and yᵢ can take a value of 0 or 1, where xᵢ=yᵢ=0 indicates that a segment is not contained in both routes and xᵢ=yᵢ=1 indicates that a segment is contained in both routes. The Jaccard similarity index indicates which routes are most dissimilar to one another. Additional details related to identifying routes and alternate routes using Jaccard similarity index can be found, for example, in U.S. Pat. No. 10,733,877 to Neukart et al., (hereinafter “Neukart”), the disclosure of which is hereby incorporated by reference in its entirety.

Returning to FIG. 1, quantum computing interface subsystem 114 may be configured to generate and provide quantum optimization data to quantum computing system 160. In one or more examples, the quantum optimization data may comprise the pre-selected route of each of the plurality of vehicles, the set of alternative routes for each of the subset of vehicles, and an indication of each vehicle as being the first type of vehicle or the second type of vehicle. In some embodiments, quantum computing system 160 is a quantum annealer. In one or more examples, the quantum optimization data comprises data for formulating a quantum unconstrained binary optimization (QUBO) problem to be solved by quantum computing system 160 (e.g., the quantum annealer).

When formulating the QUBO problem, a constraint can be included that requires each vehicle of the multi-class vehicle network be assigned one of the alternate routes from the set of alternate routes. Additionally, the QUBO problem may include one or more constraints, such as that total traffic congestion over all assigned routes is to be minimized. It is important to emphasize that in this example each vehicle was presented with three candidate alternate routes, not the same set of three routes for all vehicles. This need not be the case in general as the vehicles can have many possible routes.

For every possible assignment of vehicle to route, a binary variable pᵢⱼ may be defined, where i corresponds to the i-th vehicle taking the route j-th route. Because each vehicle can only occupy one route at a time, exactly one variable per vehicle must be true. Thus, a constraint can be imposed requiring every vehicle is required to take exactly one route. As described in Neukart, the constraint for assigning three possible alternate routes is expressed via Equation 2.

$$0 = {( {\sum }_{j ϵ \{ 1 , 2 , 3 \}} {p}_{ij} - 1 )}^{2} = - {p}_{i 1} - {p}_{i 2} - {p}_{i 3} + 2 {p}_{i 1} {p}_{i 2} + 2 {p}_{i 2} {p}_{i 3} + 2 {p}_{i 1} {p}_{i 3} + 1. \qquad Equation 2$$

In Equation 2, the number of pᵢⱼ as the binary variable have been minimized. For segment c of a plurality of segments C forming the street network (e.g., street network 200 of FIG. 2A), all binary variables pᵢⱼ that share street segment c may be identified. The set of segments B_{c} therefore many include one or more segments where traffic congestion is predicted to occur at a predetermined future time. The cost function to be used for the traffic flow optimization problem can thus be formulated as the occupancy cost function, which is represented below in Equation 3.

$$cost ( c ) = {( {\sum }_{{p}_{ij} ϵ {B}_{s}} {k}_{i} {p}_{i j} )}^{2} . \qquad Equation 3$$

In Equation 3, the term kᵢ represents a penalty associated with the i-th vehicle. The penalty may be specified based on the type of vehicle. For example, a first penalty may be applied for vehicles of the first type and a second penalty may be applied for vehicles of the second type. In some embodiments, the penalty, k, may be assigned by a user. For example, a predefined penalty may be input by the user for vehicles of different types. Each of i vehicles may have a corresponding penalty kᵢ. In some embodiments, the penalty kᵢ may be dependent on the relative effect that the i-th vehicle has on traffic congestion. For example, a truck may cause more congestion so it may be assigned a penalty factor of 4 as opposed to car with penalty factor of 1. In case of bike, since it does not cause much relative congestion the penalty factor for bike maybe 0.5.

In one or more examples, the value assigned to each of penalties kᵢ may be determined algorithmically. For example, vehicle dimensions may be used to classify a vehicle into a class, where each class may have an assigned penalty value. The vehicle's area, volume, perimeter length, total length, total width, total height, weight, occupancy capacity, and the like may be used to score the vehicle. The vehicle's score may be computed and placed in one of the possible classes. The penalty associated with the class may be assigned to that vehicle based on the vehicle's dimensions. As an example, if There may be 3 classes: small vehicles (e.g., bikes, motorcycles, scooters, etc.), medium vehicles (e.g., sedan, SUV, etc.), large vehicles (e.g., buses, trucks, etc.). Each class may have a pre-defined penalty value. For example, vehicles classified as being one of the “small vehicles” may be assigned a first penalty (e.g., kᵢ=k₁), vehicles classified as being one of the “medium vehicles” may be assigned a second penalty (e.g., kᵢ=k₂), vehicles classified as being one of the “large vehicles” may be assigned a third penalty (e.g., kᵢ=k₃).

In some embodiments, the vehicle's dimensions may be computed from obtained measures of the vehicle provided by a vehicle manufacturer, publicly available resources, and/or measured directly. In some embodiments, the vehicle's dimensions may be computed using sensor data from other vehicles, infrastructure (e.g., smart-city) sensors, and/or the vehicle itself.

In some embodiments, the value for each of penalties kᵢ may be determined based on vehicle motion data. For example, a typical envelope of the vehicle while driving may be computed from vehicle sensor data. In some examples, the vehicles average envelope across a route may be used to determine the penalty. Similar to above, the envelope of the vehicle may serve as a basis for classifying the vehicle into one of a set of vehicle classes, each associated with a value for penalty kᵢ.

In general, there can be many vehicle/route variables pᵢⱼ that share one or more segments. For example, Equation 3 provides a linear term for each of the binary variables with a coefficient of +1 and a quadratic mixed term for every combination of two binary variables with a coefficient of +2. The global cost function for the QUBO problem can now be described by summing the cost functions for each segment and the constraint from Equation 2.

In Equation 4, the constraint from Equation 2 is combined with the cost function to obtain Equation 4:

$$Obj = {\sum }_{c ϵ C} cost ( c ) + α {\sum }_{i} {( {\sum }_{j} {p}_{i j} - 1 )}^{2} . \qquad Equation 4$$

In Equation 4, a corresponds to a scaling parameter. The scaling parameter a can confirm the minimum QUBO for each vehicle according to Equation 3. A value of the scaling parameter a may be determined by finding the maximum number of times some vehicle i in the cost function (Equation 3). This makes the cost of violating Equation 3 greater than the cost of increasing the segment occupancy in every route (by 1).

The cost function can be formulated as a quadratic upper-triangular matrix, which is needed for solving QUBO problems. The binary variable pᵢⱼ can be mapped to an index in the QUBO matrix Q, given by I(i, j). These indices form the diagonals of the QUBO matrix. The elements of the matrix correspond to the coefficients of the terms from the cost function (Equation 3). The elements of the matrix are the coefficients of the terms in the cost function.

To add these elements to the QUBO matrix, the following process can be followed: If routes j and j′ share a street segment s:
1. α+1, linear in the binary variable at diagonal index I(i,j), for every vehicle i proposed with route j containing segment s.
2. A quadratic mixed term+2, for every pair of vehicles i₁ and i₂ taking route j containing segment s, is added.

Then, the constraints to enforce that every vehicle has only one route, as per Equation 2, are added:
1. For every vehicle i with possible route j, (−α) is added to the diagonal of Q given by index I(i, j).
2. For every cross-term arising from Equation 2, (2α) is added to the corresponding off-diagonal term.

A special case occurs if a vehicle is proposed only one route, meaning qᵢⱼ=1. As stated previously, despite vehicle i being assigned to route j, this assignment still affects other vehicles. This forces the quadratic constraint terms from Equation 3 to be turned into additional linear terms: 2 qᵢⱼq_{i′j′}→2q_{i′j′}.

Additionally, by keeping a record of which routes every segment appears in, redundant constraints may be removed, as some routes may overlap in more than one segment.

An Ising model may be constructed from the QUBO matrix. Additional details regarding this construction are described in Neukart.

In some embodiments, quantum computing interface subsystem 114 may be configured to receive, from quantum computing system 160, an updated route for at least some of the plurality of vehicles. The updated route(s) may minimize the traffic congestion at the predetermined future time. In one or more examples, the routes of some or all of the vehicles identified as being present on the segment for which traffic congestion is predicted to occur, may be updated based on the solution obtained from quantum computing system 160. It should be noted that some vehicles of the multi-class vehicle network may not have their route updated/changed. However, some examples include each of the vehicles of the multi-class vehicle network having their route updated based on the solution from quantum computing system 160.

In some embodiments, vehicle routing subsystem 112 may be configured to re-distribute the plurality of vehicles of the multi-class vehicle network about the street network based on the updated route of the at least some of the plurality of vehicles. In one or more examples, each updated route comprises at least one segment to be traveled by a corresponding vehicle. For example, one or more alternative segments of the plurality of segments of the street network may be selected for a vehicle to travel from a source to a destination. In some examples, an updated route for a vehicle may have a same source and destination as the pre-selected route of the vehicle. In one or more cases, a source and/or a destination of the vehicle may be adjusted for the updated route. However, this option may increase computational complexity.

In some embodiments, vehicle routing subsystem 112 may be configured to update the multi-class vehicle network such that the at least some of the plurality of vehicles are configured to travel along the updated route and each vehicle of the plurality of vehicles that did not have its pre-selected route updated is configured to travel along a corresponding pre-selected route. For example, FIG. 2A illustrates an example of a given vehicle's pre-selected route, whereas FIG. 2C illustrates an example of an updated route assigned to that vehicle.

In one or more examples, the predetermined future time comprises a first predetermined future time, the one or more segments comprise one or more first segments, and the one or more vehicles comprise one or more first vehicles. In some embodiments, traffic congestion prediction subsystem 110 may be configured to determine, using the trained machine learning model, one or more second segments of the plurality of segments of the street network where traffic congestion is predicted to occur at a second predetermined future time. In some examples, the one or more second segments are occupied at the second predetermined future time by one or more second vehicles of the plurality of vehicles each traveling along the updated route or the pre-selected route.

In some examples, after the routes of one or more of the vehicles of the multi-class vehicle network have been updated so as to minimize traffic congestion, the updated routes can be input to the trained machine learning model implemented by traffic congestion prediction subsystem 110. Traffic congestion prediction subsystem 110 may be configured to detect the second segments where traffic congestion is predicted at the second future time. In one or more examples, a segment from the first segments (predicted to have traffic congestion at the first future time) and a segment from the second segments (predicted to have traffic congestion at the second future time) may be the same. In some embodiments, one or more vehicles that travel along a segment from the first segments (during the first future time) may also travel along a same segment from the second segments (during the second future time).

In one or more examples, the subset of vehicles comprises a first subset of vehicles, the set of alternative routes comprises a first set of alternative routes, the quantum optimization data comprises first quantum optimization data, and the updated route comprises a first updated route. In some embodiments, traffic congestion prediction subsystem 110 may be configured to identify a second subset of vehicles of the plurality of vehicles occupying the one or more second segments at the second predetermined future time. As mentioned above, the first subset of vehicles may correspond to the vehicles determined to be traveling along the one or more segments where traffic congestion is predicted to occur during the first future time. The second subset of vehicles may be determined by identifying, for each of the second segments (predicted to experience traffic congestion during the second future time), which vehicles of the multi-class vehicle network traveling along those segments.

Vehicle routing subsystem 112 may select, for each vehicle of the second subset of vehicles, a second set of alternative routes based on the pre-selected route or the updated route of the vehicle. In some embodiments, vehicle routing subsystem 112 may determine a plurality of candidate routes for each vehicle of the multi-class vehicle network. Vehicle routing subsystem 112 may, as detailed above with respect to the first set of alternative routes, calculate a similarity metric, such as a Jaccard Similarity Index. Using the similarity metric, vehicle routing subsystem 112 may determine which routes are the most dissimilar to the updated route (the initial solution to the QUBO problem obtained by quantum computing system 160 and provided to computing system 102 when re-distributing the vehicles of the multi-class vehicle network). Vehicle routing subsystem 112 may select the second set of alternative routes based on the calculated similarity scores. For example, the k-most dissimilar routes may be selected for inclusion within the second set of alternative routes for each of the second set of vehicles.

Quantum computing interface subsystem 114 may be configured to generate and provide second quantum optimization data to quantum computing system 160. For example, using the “pre-selected” route (which may be the initial updated route), the second set of alternative routes, and the vehicle type, quantum computing interface subsystem 114 may generate the second quantum optimization data. The second quantum optimization data may be similarly formulated as described above with respect to the first quantum optimization data. Quantum computing interface subsystem 114 may provide the second quantum optimization data to quantum computing system 160, which may execute one or more quantum computing operations to arrive at a solution to the QUBO problem described by the second quantum optimization data.

In some embodiments, quantum computing interface subsystem 114 may receive, from quantum computing system 160, a second updated route for at least some of the plurality of vehicles that minimize the traffic congestion at the second predetermined future time. The second updated route may differ from the first updated route. In some examples, one or more segments included within the pre-selected route, the first updated route, and/or the second updated route may be the same. In some embodiments, the second updated routes may include no overlapping segments with respect to the initial (e.g., pre-selected) route or the first updated route. In one or more examples, the identifying, selecting, providing, and receiving for a predefined number of iterations. The process may repeat until the predefined number of iterations have been performed and/or until routes are selected for the plurality of vehicles of the multi-class vehicle network that have a minimum amount of traffic congestion across each segment of the plurality of segments of the street network.

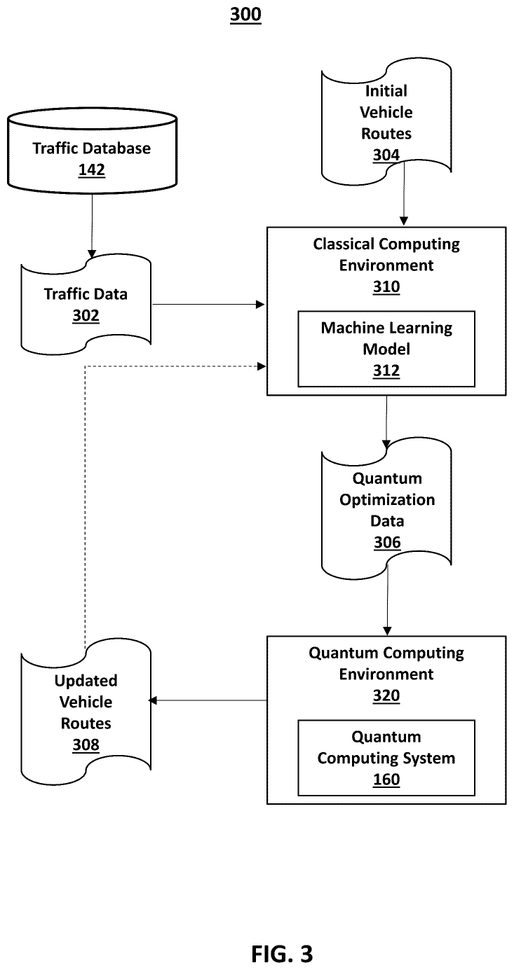

As an example, with reference to FIG. 3, an example process 300 for optimizing traffic flow of a multi-class vehicle network is described. Process 300 may begin with traffic data 302. Traffic data 302 may be provided to classical computing environment 310. For example, computing system 102 may be implemented within classical computing environment 310. In one or more examples, traffic database 142 may also reside within classical computing environment 310, however for illustrative purposes it is located external to classical computing environment 310. In some embodiments, classical computing environment 310 may include a machine learning model 312. Machine learning model 312 may be trained predict segments within a street network that will experience traffic congestion, or more generally traffic flow minimization, at a predetermined future time (or times). For example, machine learning model 312 may use traffic data 302 to identify learn patterns in traffic flow for identifying segments of the street network (e.g., street network 200 of FIG. 2A) that likely will experience traffic flow minimization at one or more future times.

Traffic data 302 may comprise data associated with the vehicles of the multi-class vehicle network. For example, with reference to FIG. 4, traffic database 142 may store vehicle location data 400. Traffic data 302 may include some or all of vehicle location data. In some examples, traffic data 302 may include a subset of vehicle location data 400. In one or more examples, traffic data 302 may include additional information. Some or all of vehicle location data 400 along with other information about one or more of the vehicles of the multi-class vehicle network may be included within traffic data 302. For example, a source and/or destination associated with a given vehicle's route may be included in traffic data 302.

Vehicle location data 400 may include a list of vehicles forming the multi-class vehicle network. For example, vehicle location data may include M vehicles having identifiers V0-VM. In one or more examples, the number of vehicles, M, can be 10² or more vehicles, 10⁴ or more vehicles, 10⁶ or more vehicles, and the like.

Vehicle location data 400 may also include an indication of a vehicle type of each of the M vehicles of the multi-class vehicle network. Each vehicle type refers to a given vehicle's class. For example, the vehicles of the multi-class vehicle network may include automobiles, buses, trucks, motorcycles, bicycles, and the like. Depending on the vehicle's type, the amount of a given segment of the street network occupied by that vehicle may vary. For example, a small automobile may occupy less area of a street than a bus. Therefore, the occupancy of the segment may depend on the number of vehicles traveling along that segment during a given time interval, as well as the types of vehicles.

Vehicle location data 400 may also include a route identifier indicating a route that a corresponding vehicle will travel. The route for each vehicle may have a particular source/start and a particular destination/end. Each route may include one or more segments. A segment refers to a unit of a street network. For example, a segment may correspond to a “street” or “road.” In some embodiments, the street network may be comprised of a plurality of segments. In one or more examples, each segment may have a same size (e.g., such that it can be occupied by a same number and/or type of vehicle(s)).

In some embodiments, vehicle location data 400 may comprise vehicle location information for some or all of the vehicles of the multi-class vehicle network at N times. For example, a plurality of vehicles of a multi-class vehicle network may be outfitted with one or more sensors configured to record geographic positions of the vehicle, and the sensors may repeat the measurement at a predefined cadence (e.g., every second, every 5 seconds, every minute, etc.). In some embodiments, the sensors of every vehicle of the multi-class vehicle network may record their geographic position at a same or approximately the same time (e.g., negligibly different times).

In some embodiments, vehicle location data 400 may additionally store travel durations for each vehicle of the multi-class vehicle network while traveling along their respective routes. For example, the time Tsource that the vehicle was determined to be located at its route's source and the time Tdestination that the vehicle was determined to be located at its route's destination may be used to compute the travel duration Ti. In some embodiments, vehicle location data may store travel duration of each vehicle along each segment (e.g., time to travel from a beginning of one segment to an end of that segment), an average time/velocity of the vehicles along a given segment, or other information.

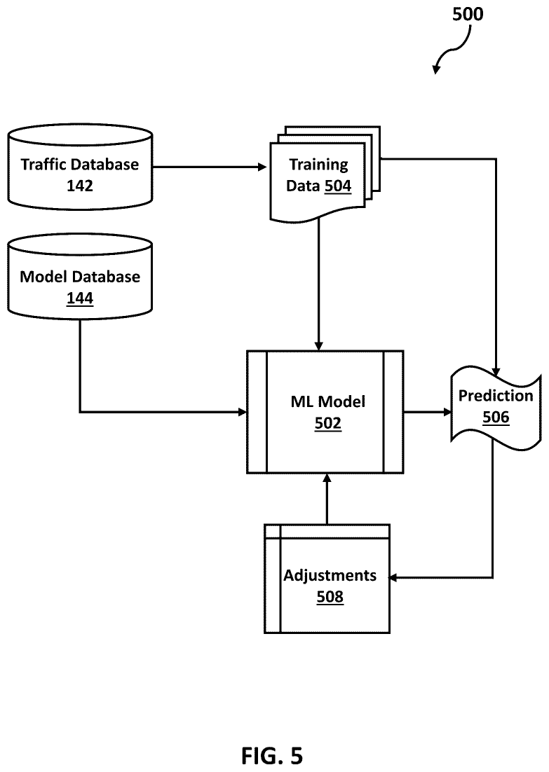

Additional details relating to training machine learning model 312 is described with respect to FIG. 5. As an example, with reference to FIG. 5, traffic congestion prediction subsystem 110 may be configured to perform process 500 to train a machine learning model 502. Persons of ordinary skill in the art will recognize that other training processes may be used to train a machine learning model used by components of system 100. Thus, process 500 should not be construed as limiting the disclosed embodiments to particular training processes. In process 500, training data 504 may be retrieved from traffic database 142. Different training data may be used to train different types of machine learning models. Furthermore, validation data may also be stored in traffic database 142. The training data and the validation data may be identified and retrieved prior to the training process beginning. In some embodiments, training data 504 may comprise traffic data 302, vehicle location data 400, or other information, or combinations thereof.

In some embodiments, training data 504 may include geographic locations of a plurality of vehicles of a multi-class vehicle network and at one or more future times. Training data 504 may be curated from geographic position sensors stored on vehicles of the vehicle network. For example, the vehicle's sensors may sample a geographic position measurement at a predefined cadence. The positional information may be stored in vehicle location data 400, as described above. Additionally, training data 504 may also indicate a route traveled by each vehicle (e.g., via a route identifier), a travel duration for the vehicle, a source/destination of the vehicle, a vehicle type of the vehicle, or other information. In some embodiments, one or more additional parameters may be generated based on vehicle location data 400, and these parameters may be included within training data 504. For example, an average speed, travel duration, flux, etc., for one or more segments of the street network may be computed based on vehicle location data 400.

In some embodiments, traffic congestion prediction subsystem 110 may select a to-be-trained machine learning model (e.g., machine learning model 502), which may be retrieved from model database 144. Machine learning model 502 may be selected based on a type of the number of vehicles included in the vehicle network, a number of classes of vehicles (e.g., how many types of vehicles are included) in the vehicle network, a number of possible routes between a given source and destination pair, or other information, or combinations thereof. Traffic congestion prediction subsystem 110 may select training data 504, which may be retrieved from traffic database 142. Traffic congestion prediction subsystem 110 may select training data 504 from one or more sets of existing training data, which may be stored in a training data database or traffic database 142 and/or model database 144, based on a type of machine learning model that was selected.

Training data 504 may be provided to machine learning model 502. Training data 504 may include vehicle location data 400. Training data 504 may be input to machine learning model 502, which may generate a prediction 506. Prediction 506 may indicate, amongst other information, a segment or segments of the street network for which the vehicles of the multi-class vehicle network travel that is likely to experience traffic flow minimization at a particular future time or times.

Prediction 506 may be compared to a ground truth identified from training data 504. In some embodiments, training data may also include annotations indicating which segments did experience traffic flow minimization. Therefore, prediction 506 may indicate whether machine learning model 502 correctly identified the segments where traffic congestion will occur. The ground truth may be compared to prediction 506, and one or more adjustments 508 may be determined. Adjustments 508 may be made to one or more hyper-parameters of machine learning model 502. The adjustments to the hyper-parameters may be to improve predictive capabilities of machine learning model 502. For example, based on the comparison, weights and/or biases of one or more nodes of machine learning model 502 may be adjusted. Process 500 may repeat until an accuracy of machine learning model 502 reaches a predefined accuracy level (e.g., 95% accuracy or greater, 99% accuracy or greater, etc.), at which point machine learning model 502 may be stored in model database 144 as a trained machine learning model. The accuracy of machine learning model 502 may be determined based on a number of correct predictions (e.g., prediction 506).

Returning to FIG. 3, initial vehicle routes 304 may be input to machine learning model 312, which may be trained to output quantum optimization data 306. In some embodiments, initial vehicle routes 304 may be determined based on a networking model (e.g., NetworkX). Quantum optimization data 306 may be input to quantum computing system 160 residing on quantum computing environment 320. In some embodiments, quantum optimization data 306 may include the one or more segments predicted to experience traffic congestion at a future time, one or more alternative routes selected for each vehicle determined to be located on a segment predicted to experience traffic congestion at a future time, or a type of vehicle, or other data, or combinations thereof. The alternative routes may be selected based on their similarity (e.g., a number of overlapping segments). In some examples, a Jaccard Similarity Index may be used as the metric for measuring how similar two routes are. The alternative routes may be selected based on their similarity score indicating that each alternative route is the most dissimilar to the pre-selected route for that vehicle. In some embodiments, quantum optimization data 306 may formulate quantum optimization data 306 as a QUBO problem comprising a QUBO matrix Q, as detailed above.

Quantum optimization data 306 may be input to quantum computing system 160 to obtain a solution to the QUBO problem, where the solution includes updated vehicle routes 308. Updated vehicle routes 308 may be identified for one or more vehicles of the multi-class vehicle network. For example, the vehicles for which updated routes are generated may comprise one or more of the vehicles located on one or more of the segments predicted to experience traffic flow minimization.

In some embodiments, updated routes 308 may be input again to machine learning model 312. Machine learning model 312 may then determine one or more additional segments for which traffic flow minimization is predicted to occur at a future time. Using these additional segments, additional quantum optimization data may be generated and provided to quantum computing system 160 to determine further updated routes. Process 300 may repeat a predefined number of times.

Quantum computing system 160 may employ a quantum annealing approach. In one or more examples, quantum computing system 160 may comprise 10 or more qubits, 100 or more qubits, 1,000 or more qubits, 5,000 or more qubits, and the like. In one or more examples, quantum computing system 160 may comprise 100 or more couples, 1,000 or more couplers, 10,000 or more couples, and the like. For example, quantum computing system 160 may comprise 40,000+ couplers. Quantum computing system 160 may include millions of Josephson junctions forming the superconducting integrated circuit. Due to the large number of connections, quantum computing system 160 having the parameters described above can be used to embed large problems with lesser physical qubits.

Quantum computing system 160 may include one or more quantum processing units (QPUs). The QPU's can dictate the translation of a QUBO or Ising objective function into a format that quantum computing system 160 can solve. Such binary objective functions can be represented as graphs, which can in turn can be mapped to the QPU. The QPU's architecture may include a repeated structure where each qubit is coupled to one or more oppositely aligned and one or more similarly aligned, qubits. A basic unit cell may include such qubits each coupled to one similarly aligned qubit in the cell and two similarly aligned qubits in adjacent cells. Alternative quantities of qubits may also be employed. In some embodiments, the global structure can be seen as a system of diagonally arranged bicliques, with couplers between oppositely aligned qubits both within and between the diagonals.

Some quantum-classical hybrid solvers can be used to solve arbitrary application problems formulated as quadratic models. In one or more examples, quantum computing system 160 may implement a quantum-classical hybrid solver. In some embodiments, quantum optimization data 306 may comprise a problem submitted directly to quantum computing system 160. For example, quantum optimization data 306 may be in the binary quadratic model (BQM) format, unconstrained with binary-valued variables and structured for the topology of a quantum processing unit (QPU). Hybrid solvers may accept arbitrarily structured quadratic models (QM), constrained or unconstrained, with both integer and binary variables. These solvers, which implement state-of-the-art classical algorithms together with intelligent allocation of the quantum computer to parts of the problem where it benefits most, are designed to accommodate even very large problems.

Quantum computing system 160 may execute the solving process, which may take time to complete. The execution times can be of the order of 10-20 ms. The access time can be segmented into a one-time initialization step to program the QPU of quantum computing system 160 (programming time) and sampling times for execution on the QPU (sampling time) of quantum computing system 160. In order to be fair and measure only the time taken to obtain one solution in the quantum machine, the sampling time, which is broken down into anneal (anneal time), the read of the sample from the QPU (readout time) and thermalization (time for the QPU to hit again its initial temperature, delay time) may be used. The time taken to obtain each solution may then be given by the sum of the QPU times for each sample: anneal time, readout time and delay time

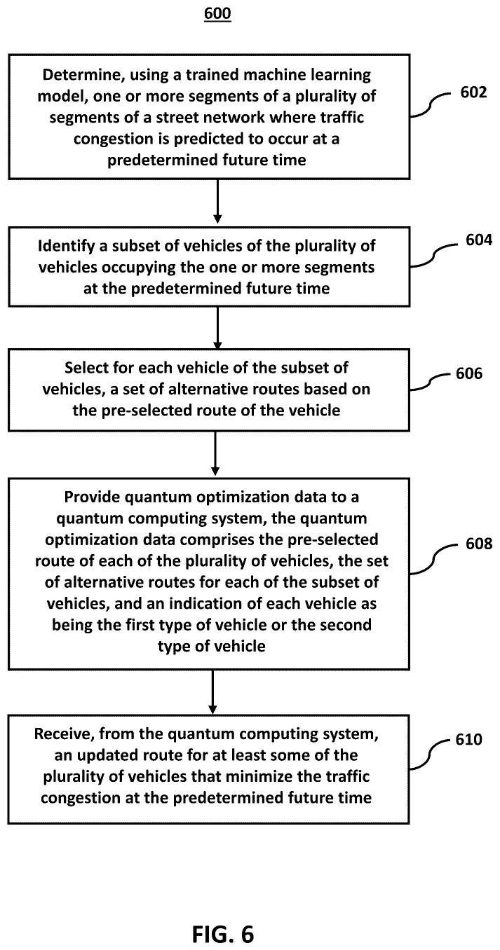

FIG. 6 illustrates a flowchart of an example method 600 for optimizing real-time traffic flow in a multi-class vehicle network, in accordance with various embodiments. In certain embodiments, method 600 may be executed utilizing one or more processing devices (e.g., computing system 700 that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other processing device(s) that may be suitable for processing genomics data, proteomics data, metabolomics data, metagenomics data, transcriptomics data, or other omics data and making one or more decisions based thereon), software (e.g., instructions running/executing on one or more processors), firmware (e.g., microcode), or some combination thereof.

In some embodiments, method 600 may begin at step 602. At step 602, one or more segments of a plurality of segments of a street network where traffic congestion is predicted to occur at a predetermined future time may be determined using a trained machine learning model operating on a classical computing system. In one or more examples, the street network comprises a plurality of segments, and each pre-selected route comprises at least one of the plurality of segments. Each segment may have a same occupancy constraint. The occupancy constraint may indicate a maximum amount of the first type of vehicle and a maximum amount of the second type of vehicle operable to occupy the segment. In some embodiments, step 602 may be performed by a subsystem that is the same or similar to traffic congestion prediction subsystem 110.

At step 604, a subset of vehicles of the plurality of vehicles occupying the one or more segments at the predetermined future time may be identified using the classical computing system. For example, with reference again to FIG. 2B, vehicle routing subsystem 112 may determine that vehicles 210-218 are each traveling along segment 206 during a predetermined future time, and segment 206 is predicted as having traffic flow minimized during the predetermined future time. In some embodiments, step 604 may be performed by a subsystem that is the same or similar to vehicle routing subsystem 112.

At step 606, for each vehicle of the subset of vehicles, a set of alternative routes may be selected based on the pre-selected route of the vehicle using the classical computing system. In one or more examples, selecting the set of alternative routes may comprise, for each vehicle of the subset of vehicles, identifying a plurality of candidate routes based on the pre-selected route. Each candidate route may include a same source and destination as the pre-selected route. In some examples, a similarity score indicating how similar each candidate route is to the pre-selected route may be computed. For example, the similarity score may be higher when the pre-selected route and the candidate route share more segments. In some embodiments, step 606 may be performed by a subsystem that is the same or similar to vehicle routing subsystem 112.

At step 608, quantum optimization data may be provided to a quantum computing system. The quantum optimization data may include the pre-selected route of each of the plurality of vehicles, the set of alternative routes for each of the subset of vehicles, and an indication of each vehicle as being the first type of vehicle or the second type of vehicle. In one or more examples, the quantum optimization data may comprise the pre-selected route of each of the plurality of vehicles, the set of alternative routes for each of the subset of vehicles, and an indication of each vehicle as being the first type of vehicle or the second type of vehicle. In some embodiments, quantum computing system 160 is a quantum annealer. In one or more examples, the quantum optimization data comprises data for formulating a quantum unconstrained binary optimization (QUBO) problem to be solved by quantum computing system 160 (e.g., the quantum annealer). In some embodiments, step 608 may be performed by a subsystem that is the same or similar to quantum computing interface subsystem 114.

At step 610, an updated route for at least some of the plurality of vehicles may be received at the classical computing system from the quantum computing system. The updated route may minimize the traffic congestion at the predetermined future time. In one or more examples, the routes of some or all of the vehicles identified as being present on the segment for which traffic congestion is predicted to occur, may be updated based on the solution obtained from quantum computing system 160. In some embodiments, step 610 may be performed by a subsystem that is the same or similar to quantum computing interface subsystem 114.

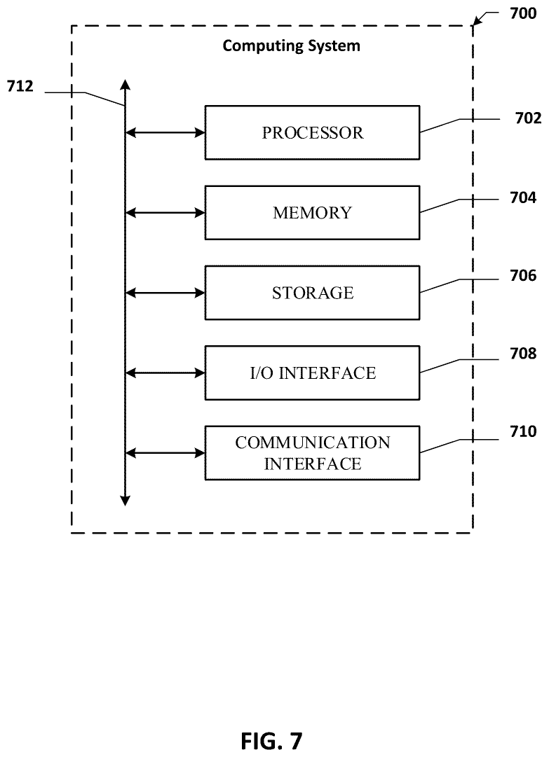

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example, and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example, and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example, and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example, and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example, and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example, and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### EXAMPLE EMBODIMENTS

Embodiments disclosed herein may include:

1. A method for optimizing real-time traffic flow of a multi-class vehicle network, the method being implemented by one or more processors of a computing system, the method comprising: determining, using a trained machine learning model operating on a classical computing system, one or more segments of a plurality of segments of a street network where traffic congestion is predicted to occur at a predetermined future time, wherein the one or more segments are predicted to be occupied at the predetermined future time by one or more vehicles of a plurality of vehicles of a multi-class vehicle network each traveling along a pre-selected route, wherein the plurality of vehicles include a first type of vehicle and a second type of vehicle, and wherein the first type of vehicle occupies a first portion of a segment and the second type of vehicle occupies a second portion of the segment; identifying, using the classical computing system, a subset of vehicles of the plurality of vehicles occupying the one or more segments at the predetermined future time; selecting, using the classical computing system, for each vehicle of the subset of vehicles, a set of alternative routes based on the pre-selected route of the vehicle; providing quantum optimization data to a quantum computing system, the quantum optimization data comprising the pre-selected route of each of the plurality of vehicles, the set of alternative routes for each of the subset of vehicles, and an indication of each vehicle as being the first type of vehicle or the second type of vehicle; and receiving, at the classical computing system, from the quantum computing system, an updated route for at least some of the plurality of vehicles that minimizes the traffic congestion at the predetermined future time.

2. The method of embodiment 1, wherein the street network comprises a plurality of segments, and each pre-selected route comprises at least one of the plurality of segments.

3. The method of embodiment 2, wherein each segment of the plurality of segments has a same occupancy constraint.

4. The method of embodiment 3, wherein the occupancy constraint indicates a maximum amount of the first type of vehicle and a maximum amount of the second type of vehicle operable to occupy the segment.

5. The method of any one of embodiments 1-4, further comprising: re-distributing the plurality of vehicles about the street network based on the updated route of the at least some of the plurality of vehicles.

6. The method of embodiment 5, further comprising: generating routing data for the at least some of the plurality of vehicles, wherein the routing data comprises the updated route; and providing the routing data to the at least some of the plurality of vehicles.

7. The method of any one of embodiments 1-6, wherein each pre-selected route and updated route comprise at least one segment to be traveled by a corresponding vehicle.

8. The method of any one of embodiments 1-7, wherein selecting comprises: for each vehicle of the subset of vehicles: identifying, based on the pre-selected route, a plurality of candidate routes, wherein each candidate route includes a same source and a same destination as the pre-selected route; computing, for each of the plurality of candidate routes, a similarity score indicating how similar the candidate route of the vehicle is to the pre-selected route of the vehicle; and selecting the set of alternative routes based on the similarity score computed for each of the plurality of candidate routes.

9. The method of embodiment 8, wherein the set of alternative routes comprise routes that are most dissimilar to the pre-selected route.

10. The method of embodiment 8 or 9, wherein the set of alternative routes comprise at least three alternative routes.

11. The method of any one of embodiments 8-10, wherein computing the similarity score comprises: computing a Jaccard Similarity Index based on the candidate route and the pre-selected route.

12. The method of any one of embodiments 1-11, wherein the quantum computing system is a quantum annealer.

13. The method of embodiment 12, wherein the quantum optimization data comprises data for formulating a quantum unconstrained binary optimization (QUBO) problem to be solved by the quantum annealer.

14. The method of any one of embodiments 1-13, further comprising: updating the multi-class vehicle network such that the at least some of the plurality of vehicles are configured to travel along the updated route and each vehicle of the plurality of vehicles that did not have its pre-selected route updated is configured to travel along a corresponding pre-selected route.

15. The method of embodiment 14, wherein the predetermined future time comprises a first predetermined future time, the one or more segments comprise one or more first segments, and the one or more vehicles comprise one or more first vehicles, the method further comprises: determining, using the trained machine learning model operating on the classical computing system, one or more second segments of the plurality of segments of the street network where traffic congestion is predicted to occur at a second predetermined future time, wherein the one or more second segments are occupied at the second predetermined future time by one or more second vehicles of the plurality of vehicles each traveling along the updated route or the pre-selected route.

16. The method of embodiment 15, wherein the subset of vehicles comprises a first subset of vehicles, the set of alternative routes comprises a first set of alternative routes, the quantum optimization data comprises first quantum optimization data, and the updated route comprises a first updated route, the method further comprises: identifying, using the classical computing system, a second subset of vehicles of the plurality of vehicles occupying the one or more second segments at the second predetermined future time; selecting, using the classical computing system, for each vehicle of the second subset of vehicles, a second set of alternative routes based on the pre-selected route or the updated route of the vehicle; providing second quantum optimization data to the quantum computing system; and receiving, at the classical computing system, from the quantum computing system, a second updated route for at least some of the plurality of vehicles that minimizes the traffic congestion at the second predetermined future time.

17. The method of embodiment 15 or 16, repeating the identifying, selecting, providing, and receiving for a predefined number of iterations.

18. The method of any one of embodiments 1-17, further comprising: accessing traffic flow data indicating locations about the street network where each of the plurality of vehicles is located during a plurality of prior time intervals, wherein the traffic flow data is input to the trained machine learning model to obtain the one or more segments of the street network where traffic congestion is predicted to occur at the predetermined future time.

19. The method of embodiment 18, wherein the trained machine learning model is trained to detect the one or more segments by: determining a vehicle-segment occupancy score for each segment during each of a plurality of future time intervals; and selecting the one or more segments based on the vehicle-segment occupancy score for each of the one or more segments being greater than or equal to a threshold vehicle-segment occupancy score.

20. The method of embodiment 19, wherein the vehicle-segment occupancy score is computed by: determining a number of vehicles of the first type of vehicle and a number of vehicles of the second type of vehicle occupying a same segment at the plurality of future time intervals; and for each same segment: calculating a first amount of space occupied by the number of vehicles of the first type of vehicle; and calculating a second amount of space occupied by the number of vehicles of the second type of vehicle, wherein the vehicle-segment occupancy score is computed based on the first amount of space occupied, the second amount of space occupied, and a maximum vehicle-segment occupancy amount.

21. The method of embodiment 20, further comprising: updating a pre-selected route for a vehicle by modifying the number of vehicles of the first type of vehicle and the number of vehicles of the second type of vehicle that will occupy the same segment during one of the plurality of future time intervals such that the vehicle-segment occupancy score satisfies a vehicle-segment occupancy threshold condition, the vehicle-segment occupancy threshold condition being satisfied comprises the vehicle-segment occupancy score being less than or equal to a threshold vehicle-segment occupancy score.

22. The method of any one of embodiments 1-22, further comprising: for each vehicle of the plurality of vehicles of the multi-class vehicle network: determining a source of the vehicle and a destination of the vehicle; and selecting the pre-selected route of the vehicle based on the source and the destination.

23. The method of embodiment 22, wherein the pre-selected route is selected from a plurality of routes between the source and the destination based on a quantity of segments forming the pre-selected route.

24. The method of any one of embodiments 1-23, further comprising: distributing the plurality of vehicles of the multi-class vehicle network about the street network to respective sources and destinations of each vehicle.

25. The method of any one of embodiments 1-24, wherein determining the one or more segments comprises: identifying, using the trained machine learning model, patterns in traffic flow data indicating where traffic congestion occurs.

26. A system, comprising: a classical computing system comprising one or more processors programmed to: determine, using a trained machine learning model, one or more segments of a plurality of segments of a street network where traffic congestion is predicted to occur at a predetermined future time, wherein the one or more segments are predicted to be occupied at the predetermined future time by one or more vehicles of a plurality of vehicles of a multi-class vehicle network each traveling along a pre-selected route, wherein the plurality of vehicles include a first type of vehicle and a second type of vehicle, and wherein the first type of vehicle occupies a first portion of a segment and the second type of vehicle occupies a second portion of the segment; identify a subset of vehicles of the plurality of vehicles occupying the one or more segments at the predetermined future time; and select, for each vehicle of the subset of vehicles, a set of alternative routes based on the pre-selected route of the vehicle; and a quantum computing system programmed with quantum optimization data received from the classical computing system, wherein the quantum optimization data comprises the pre-selected route of each of the plurality of vehicles, the set of alternative routes for each of the subset of vehicles, and an indication of each vehicle as being the first type of vehicle or the second type of vehicle, wherein the quantum computing system is configured to output, to the classical computing system an updated route for at least some of the plurality of vehicles that minimizes the traffic congestion at the predetermined future time.

27. The system of embodiment 26, wherein the street network comprises a plurality of segments, and each pre-selected route comprises at least one of the plurality of segments.

28. The system of embodiment 27, wherein each segment of the plurality of segments has a same occupancy constraint.

29. The system of embodiment 28, wherein the occupancy constraint indicates a maximum amount of the first type of vehicle and a maximum amount of the second type of vehicle operable to occupy the segment.

30. The system of any one of embodiments 26-29, wherein the one or more processors are further programmed to: re-distribute the plurality of vehicles about the street network based on the updated route of the at least some of the plurality of vehicles.

31. The system of embodiment 30, wherein the one or more processors are further programmed to: generate routing data for the at least some of the plurality of vehicles, wherein the routing data comprises the updated route; and providing the routing data to the at least some of the plurality of vehicles.

32. The system of any one of embodiments 26-31, wherein each pre-selected route and updated route comprise at least one segment to be traveled by a corresponding vehicle.

33. The system of any one of embodiments 26-32, wherein the selection comprises the one or more processors being programmed to: for each vehicle of the subset of vehicles: identify, based on the pre-selected route, a plurality of candidate routes, wherein each candidate route includes a same source and a same destination as the pre-selected route; compute, for each of the plurality of candidate routes, a similarity score indicating how similar the candidate route of the vehicle is to the pre-selected route of the vehicle; and select the set of alternative routes based on the similarity score computed for each of the plurality of candidate routes.

34. The system of embodiment 33, wherein the set of alternative routes comprise routes that are most dissimilar to the pre-selected route.

35. The system of embodiment 33 or 34, wherein the set of alternative routes comprise at least three alternative routes.

36. The system of any one of embodiments 33-35, wherein the similarity score comprises a Jaccard Similarity Index computed based on the candidate route and the pre-selected route.

37. The system of any one of embodiments 26-36, wherein the quantum computing system is a quantum annealer.

38. The system of embodiment 37, wherein the quantum optimization data comprises data for formulating a quantum unconstrained binary optimization (QUBO) problem to be solved by the quantum annealer.

39. The system of any one of embodiments 26-38, wherein the one or more processors are further programmed to: update the multi-class vehicle network such that the at least some of the plurality of vehicles are configured to travel along the updated route and each vehicle of the plurality of vehicles that did not have its pre-selected route updated is configured to travel along a corresponding pre-selected route.

40. The system of embodiment 39, wherein the predetermined future time comprises a first predetermined future time, the one or more segments comprise one or more first segments, and the one or more vehicles comprise one or more first vehicles, the one or more processors are further programmed to: determine, using the trained machine learning model operating on the classical computing system, one or more second segments of the plurality of segments of the street network where traffic congestion is predicted to occur at a second predetermined future time, wherein the one or more second segments are occupied at the second predetermined future time by one or more second vehicles of the plurality of vehicles each traveling along the updated route or the pre-selected route.

41. The system of embodiment 40, wherein the subset of vehicles comprises a first subset of vehicles, the set of alternative routes comprises a first set of alternative routes, the quantum optimization data comprises first quantum optimization data, and the updated route comprises a first updated route, the one or more processors are further programmed to: identify, using the classical computing system, a second subset of vehicles of the plurality of vehicles occupying the one or more second segments at the second predetermined future time; select, using the classical computing system, for each vehicle of the second subset of vehicles, a second set of alternative routes based on the pre-selected route or the updated route of the vehicle; provide second quantum optimization data to the quantum computing system; and receive, at the classical computing system, from the quantum computing system, a second updated route for at least some of the plurality of vehicles that minimizes the traffic congestion at the second predetermined future time.

42. The system of embodiment 40 or 41, wherein the one or more processors are further programmed to repeat the identifying, selecting, providing, and receiving for a predefined number of iterations.

43. The system of any one of embodiments 26-42, wherein the one or more processors are further programmed to: access traffic flow data indicating locations about the street network where each of the plurality of vehicles is located during a plurality of prior time intervals, wherein the traffic flow data is input to the trained machine learning model to obtain the one or more segments of the street network where traffic congestion is predicted to occur at the predetermined future time.

44. The system of embodiment 43, wherein the trained machine learning model is trained to detect the one or more segments by: determining a vehicle-segment occupancy score for each segment during each of a plurality of future time intervals; and selecting the one or more segments based on the vehicle-segment occupancy score for each of the one or more segments being greater than or equal to a threshold vehicle-segment occupancy score.

45. The system of embodiment 44, wherein the vehicle-segment occupancy score is computed by: determining a number of vehicles of the first type of vehicle and a number of vehicles of the second type of vehicle occupying a same segment at the plurality of future time intervals; and for each same segment: calculating a first amount of space occupied by the number of vehicles of the first type of vehicle; and calculating a second amount of space occupied by the number of vehicles of the second type of vehicle, wherein the vehicle-segment occupancy score is computed based on the first amount of space occupied, the second amount of space occupied, and a maximum vehicle-segment occupancy amount.

46. The system of embodiment 45, wherein the one or more processors are further programmed to: update a pre-selected route for a vehicle by modifying the number of vehicles of the first type of vehicle and the number of vehicles of the second type of vehicle that will occupy the same segment during one of the plurality of future time intervals such that the vehicle-segment occupancy score satisfies a vehicle-segment occupancy threshold condition, the vehicle-segment occupancy threshold condition being satisfied comprises the vehicle-segment occupancy score being less than or equal to a threshold vehicle-segment occupancy score.

47. The system of any one of embodiments 26-46, wherein the one or more processors are further programmed to: for each vehicle of the plurality of vehicles of the multi-class vehicle network: determine a source of the vehicle and a destination of the vehicle; and selecting the pre-selected route of the vehicle based on the source and the destination.

48. The system of embodiment 47, wherein the pre-selected route is selected from a plurality of routes between the source and the destination based on a quantity of segments forming the pre-selected route.

49. The system of any one of embodiments 26-48, wherein the one or more processors are further programmed to: distribute the plurality of vehicles of the multi-class vehicle network about the street network to respective sources and destinations of each vehicle.

50. The system of any one of embodiments 26-49, wherein the one or more segments being determined comprises the one or more processors being programmed to: identify, using the trained machine learning model, patterns in traffic flow data indicating where traffic congestion occurs.

51. A classical computing system comprising one or more processors programmed to determine, using a trained machine learning model, one or more segments of a plurality of segments of a street network where traffic congestion is predicted to occur at a predetermined future time, wherein the one or more segments are predicted to be occupied at the predetermined future time by one or more vehicles of a plurality of vehicles of a multi-class vehicle network each traveling along a pre-selected route, wherein the plurality of vehicles include a first type of vehicle and a second type of vehicle, and wherein the first type of vehicle occupies a first portion of a segment and the second type of vehicle occupies a second portion of the segment; identify a subset of vehicles of the plurality of vehicles occupying the one or more segments at the predetermined future time; and select, for each vehicle of the subset of vehicles, a set of alternative routes based on the pre-selected route of the vehicle, wherein a quantum computing system is programmed with quantum optimization data received from the classical computing system, wherein the quantum optimization data comprises the pre-selected route of each of the plurality of vehicles, the set of alternative routes for each of the subset of vehicles, and an indication of each vehicle as being the first type of vehicle or the second type of vehicle, wherein the quantum computing system is configured to output, to the classical computing system an updated route for at least some of the plurality of vehicles that minimizes the traffic congestion at the predetermined future time.

52. A non-transitory computer-readable medium storing computer program instructions that, when executed, effectuate the method of any one of claims 1-25.

1. A method for optimizing real-time traffic flow of a multi-class vehicle network, the method being implemented by one or more processors of a computing system, the method comprising:
determining, using a trained machine learning model operating on a classical computing system, one or more segments of a plurality of segments of a street network where traffic congestion is predicted to occur at a predetermined future time, wherein the one or more segments are predicted to be occupied at the predetermined future time by one or more vehicles of a plurality of vehicles of a multi-class vehicle network each traveling along a pre-selected route, wherein the plurality of vehicles include a first type of vehicle and a second type of vehicle, and wherein the first type of vehicle occupies a first portion of a segment and the second type of vehicle occupies a second portion of the segment;
identifying, using the classical computing system, a subset of vehicles of the plurality of vehicles occupying the one or more segments at the predetermined future time;
selecting, using the classical computing system, for each vehicle of the subset of vehicles, a set of alternative routes based on the pre-selected route of the vehicle;
providing quantum optimization data to a quantum computing system, the quantum optimization data comprising the pre-selected route of each of the plurality of vehicles, the set of alternative routes for each of the subset of vehicles, and an indication of each vehicle as being the first type of vehicle or the second type of vehicle; and
receiving, at the classical computing system, from the quantum computing system, an updated route for at least some of the plurality of vehicles that minimizes the traffic congestion at the predetermined future time.

2. The method of claim 1, wherein the street network comprises a plurality of segments, and each pre-selected route comprises at least one of the plurality of segments.

3. The method of claim 2, wherein each segment of the plurality of segments has a same occupancy constraint.

4. The method of claim 3, wherein the occupancy constraint indicates a maximum amount of the first type of vehicle and a maximum amount of the second type of vehicle operable to occupy the segment.

5. The method of claim 1, further comprising:
re-distributing the plurality of vehicles about the street network based on the updated route of the at least some of the plurality of vehicles.

6. The method of claim 5, further comprising:
generating routing data for the at least some of the plurality of vehicles, wherein the routing data comprises the updated route; and
providing the routing data to the at least some of the plurality of vehicles.

7. The method of claim 1, wherein each pre-selected route and updated route comprise at least one segment to be traveled by a corresponding vehicle.

8. The method of claim 1, wherein selecting comprises:
for each vehicle of the subset of vehicles:
identifying, based on the pre-selected route, a plurality of candidate routes, wherein each candidate route includes a same source and a same destination as the pre-selected route;
computing, for each of the plurality of candidate routes, a similarity score indicating how similar the candidate route of the vehicle is to the pre-selected route of the vehicle; and
selecting the set of alternative routes based on the similarity score computed for each of the plurality of candidate routes.

9. The method of claim 8, wherein the set of alternative routes comprise routes that are most dissimilar to the pre-selected route.

10. The method of claim 8, wherein the set of alternative routes comprise at least three alternative routes.

11. The method of claim 8, wherein computing the similarity score comprises:
computing a Jaccard Similarity Index based on the candidate route and the pre-selected route.

12. The method of claim 1, wherein the quantum computing system is a quantum annealer.

13. The method of claim 12, wherein the quantum optimization data comprises data for formulating a quantum unconstrained binary optimization (QUBO) problem to be solved by the quantum annealer.

14. The method of claim 1, further comprising:
updating the multi-class vehicle network such that the at least some of the plurality of vehicles are configured to travel along the updated route and each vehicle of the plurality of vehicles that did not have its pre-selected route updated is configured to travel along a corresponding pre-selected route.

15. The method of claim 14, wherein the predetermined future time comprises a first predetermined future time, the one or more segments comprise one or more first segments, and the one or more vehicles comprise one or more first vehicles, the method further comprises:
determining, using the trained machine learning model operating on the classical computing system, one or more second segments of the plurality of segments of the street network where traffic congestion is predicted to occur at a second predetermined future time, wherein the one or more second segments are occupied at the second predetermined future time by one or more second vehicles of the plurality of vehicles each traveling along the updated route or the pre-selected route.

16. The method of claim 15, wherein the subset of vehicles comprises a first subset of vehicles, the set of alternative routes comprises a first set of alternative routes, the quantum optimization data comprises first quantum optimization data, and the updated route comprises a first updated route, the method further comprises:
identifying, using the classical computing system, a second subset of vehicles of the plurality of vehicles occupying the one or more second segments at the second predetermined future time;
selecting, using the classical computing system, for each vehicle of the second subset of vehicles, a second set of alternative routes based on the pre-selected route or the updated route of the vehicle;
providing second quantum optimization data to the quantum computing system; and
receiving, at the classical computing system, from the quantum computing system, a second updated route for at least some of the plurality of vehicles that minimizes the traffic congestion at the second predetermined future time.

17. The method of claim 15, repeating the identifying, selecting, providing, and receiving for a predefined number of iterations.

18. The method of claim 1, further comprising:
accessing traffic flow data indicating locations about the street network where each of the plurality of vehicles is located during a plurality of prior time intervals, wherein the traffic flow data is input to the trained machine learning model to obtain the one or more segments of the street network where traffic congestion is predicted to occur at the predetermined future time.

19. The method of claim 18, wherein the trained machine learning model is trained to detect the one or more segments by:
determining a vehicle-segment occupancy score for each segment during each of a plurality of future time intervals; and
selecting the one or more segments based on the vehicle-segment occupancy score for each of the one or more segments being greater than or equal to a threshold vehicle-segment occupancy score.

20. The method of claim 19, wherein the vehicle-segment occupancy score is computed by:
determining a number of vehicles of the first type of vehicle and a number of vehicles of the second type of vehicle occupying a same segment at the plurality of future time intervals; and
for each same segment:
calculating a first amount of space occupied by the number of vehicles of the first type of vehicle; and
calculating a second amount of space occupied by the number of vehicles of the second type of vehicle, wherein the vehicle-segment occupancy score is computed based on the first amount of space occupied, the second amount of space occupied, and a maximum vehicle-segment occupancy amount.

21. The method of claim 20, further comprising:
updating a pre-selected route for a vehicle by modifying the number of vehicles of the first type of vehicle and the number of vehicles of the second type of vehicle that will occupy the same segment during one of the plurality of future time intervals such that the vehicle-segment occupancy score satisfies a vehicle-segment occupancy threshold condition, the vehicle-segment occupancy threshold condition being satisfied comprises the vehicle-segment occupancy score being less than or equal to a threshold vehicle-segment occupancy score.

22. The method of claim 1, further comprising:
for each vehicle of the plurality of vehicles of the multi-class vehicle network:
determining a source of the vehicle and a destination of the vehicle; and
selecting the pre-selected route of the vehicle based on the source and the destination.

23. The method of claim 22, wherein the pre-selected route is selected from a plurality of routes between the source and the destination based on a quantity of segments forming the pre-selected route.

24. The method of claim 1, further comprising:
distributing the plurality of vehicles of the multi-class vehicle network about the street network to respective sources and destinations of each vehicle.

25. The method of claim 1, wherein determining the one or more segments comprises:
identifying, using the trained machine learning model, patterns in traffic flow data indicating where traffic congestion occurs.

26. A system, comprising:
a classical computing system comprising one or more processors programmed to:
determine, using a trained machine learning model, one or more segments of a plurality of segments of a street network where traffic congestion is predicted to occur at a predetermined future time, wherein the one or more segments are predicted to be occupied at the predetermined future time by one or more vehicles of a plurality of vehicles of a multi-class vehicle network each traveling along a pre-selected route, wherein the plurality of vehicles include a first type of vehicle and a second type of vehicle, and wherein the first type of vehicle occupies a first portion of a segment and the second type of vehicle occupies a second portion of the segment;
identify a subset of vehicles of the plurality of vehicles occupying the one or more segments at the predetermined future time; and
select, for each vehicle of the subset of vehicles, a set of alternative routes based on the pre-selected route of the vehicle; and
a quantum computing system programmed with quantum optimization data received from the classical computing system, wherein the quantum optimization data comprises the pre-selected route of each of the plurality of vehicles, the set of alternative routes for each of the subset of vehicles, and an indication of each vehicle as being the first type of vehicle or the second type of vehicle, wherein the quantum computing system is configured to output, to the classical computing system an updated route for at least some of the plurality of vehicles that minimizes the traffic congestion at the predetermined future time.

27. A non-transitory computer-readable medium storing computer program instructions that, when executed by one or more processors of a classical computing system, effectuate operations comprising:
determining, using a trained machine learning model, one or more segments of a plurality of segments of a street network where traffic congestion is predicted to occur at a predetermined future time, wherein the one or more segments are predicted to be occupied at the predetermined future time by one or more vehicles of a plurality of vehicles of a multi-class vehicle network each traveling along a pre-selected route, wherein the plurality of vehicles include a first type of vehicle and a second type of vehicle, and wherein the first type of vehicle occupies a first portion of a segment and the second type of vehicle occupies a second portion of the segment;
identifying a subset of vehicles of the plurality of vehicles occupying the one or more segments at the predetermined future time;
selecting for each vehicle of the subset of vehicles, a set of alternative routes based on the pre-selected route of the vehicle;
providing quantum optimization data to a quantum computing system, the quantum optimization data comprises the pre-selected route of each of the plurality of vehicles, the set of alternative routes for each of the subset of vehicles, and an indication of each vehicle as being the first type of vehicle or the second type of vehicle; and
receiving, at the classical computing system, from the quantum computing system, an updated route for at least some of the plurality of vehicles that minimizes the traffic congestion at the predetermined future time.
